(19) United States
(12) Patent Application Publication
(10) Pub. No.: US 2024/0290059 A1
(43) Pub. Date: Aug. 29, 2024

(54) EDITABLE FREE-VIEWPOINT VIDEO USING A LAYERED NEURAL REPRESENTATION

(71) Applicant: SHANGHAITECH UNIVERSITY, Shanghai (CN)

(72) Inventors: Jiakai ZHANG, Shanghai (CN); Jingyi YU, Shanghai (CN); Lan XU, Shanghai (CN)

(73) Assignee: SHANGHAITECH UNIVERSITY, Shanghai (CN)

(21) Appl. No.: 18/571,748

(22) PCT Filed: Jul. 26, 2021
(86) PCT No.: PCT/CN2021/108513

§ 371 Date: Dec. 19, 2023

(51) Int. Cl. G06V 10/25; G06T 3/02; G06T 7/50

(52) U.S. Cl. CPC G06V 10/25; G06T 3/02; G06T 7/50

(57) ABSTRACT

A computer-implemented method of generating editable free-viewport videos is provided. A plurality of video of a scene from a plurality of views is obtained. The scene comprises includes an environment and one or more dynamic entities. A 3D bounding-box is generated for each dynamic entity in the scene. A computer device encodes a machine learning model including an environment layer and a dynamic entity layer for each dynamic entity in the scene. The environment layer represents a continuous function of space and time of the environment. The dynamic entity layer represents a continuous function of space and time of the dynamic entity. The dynamic entity layer includes a deformation module and a neural radiance module. The deformation module is configured to deform a spatial coordinate in accordance with a timestamp and a trained deformation weight. The neural radiance module is configured to derive a density value and a color.

### CROSS REFERENCE TO THE RELATED APPLICATIONS

This application is the national phase entry of International Application No. PCT/CN2021/108513, filed on Jul. 26, 2021, the entire contents of which are incorporated herein by reference.

### TECHNICAL FIELD

The present invention generally relates to image processing. More particularly, the present invention relates to generating editable free-viewpoint videos based on a neural radiance field encoded into a machine learning model.

### BACKGROUND

View synthesis is widely used in computer vision and computer graphics to generate novel views (i.e., perspectives) of objects in scenes depicted in images or videos. As such, view synthesis is often used in applications, including gaming, education, art, entertainment, etc., to generate visual effects. For example, a visual effect can comprise freezing a video frame depicting an object in a scene from a first perspective and then rotating the scene to a second perspective so that the object is viewed from a different viewpoint. These visual effects are generally known as free-viewport videos. Recently, using view synthesis to generate novel views of scenes has generated a lot of interest with rise in popularity of virtual reality (VR) and augmented reality (AR) hardware and associated applications. Conventional methods of view synthesis have many disadvantages and, generally, are not suited for VR and/or AR applications. For example, conventional methods of view synthesis rely on model-based solutions to generate free-viewport videos. However, the model-based solutions of the conventional methods can limit resolution of reconstructed meshes of scenes and, as result, generate uncanny texture renderings of the scenes in novel views. Furthermore, in some cases, for dense scenes (e.g., scenes with a lot of motion), the model-based solutions can be vulnerable to occlusions which can further lead to uncanny texture renderings of scenes. Moreover, the model-based solutions generally only focus on reconstruction of novel views of scenes and are devoid of features that allow users to edit or change perception of the scenes. As such, better approaches to view synthesis are needed.

### SUMMARY

Described herein, in various embodiments, is a computer-implemented method of generating editable free-viewport videos. A plurality of video of a scene from a plurality of views can be obtained. The scene can comprise an environment and one or more dynamic entities. A 3D bounding-box can be generated for each dynamic entity in the scene. A computer device can encode a machine learning model comprising an environment layer and a dynamic entity layer for each dynamic entity in the scene. The environment layer can represent a continuous function of space and time of the environment. The dynamic entity layer can represent a continuous function of space and time of the dynamic entity. The dynamic entity layer can comprise a deformation module and a neural radiance module. The deformation module can be configured to deform a spatial coordinate in accordance with a timestamp and a trained deformation weight. The neural radiance module can be configured to derive a density value and a color in accordance with the deformed spatial coordinate, the timestamp, a direction, and a trained radiance weight. The machine learning model can be trained using the plurality of videos. The scene can be rendered in accordance with the trained machine learning model.

In some embodiments, the scene can comprise a first dynamic entity and a second dynamic entity.

In some embodiments, a point cloud for each frame of the plurality of videos can be obtained and each video can comprise a plurality of frames. A depth map for each view to be rendered can be reconstructed. An initial 2D bounding-box can be generated in each view for each dynamic entity. The 3D bounding-box for each dynamic entity can be generated using a trajectory prediction network (TPN).

In some embodiments, a mask of the dynamic object in each frame from each view can be predicted. An averaged depth value of the dynamic object can be calculated in accordance with the reconstructed depth map. A refined mask of the dynamic object can be obtained in accordance with the calculated average depth value. A label map of the dynamic object can be composited in accordance with the refined mask.

In some embodiments, the deformation module can comprise a multi-layer perceptron (MLP).

In some embodiments, the deformation module can comprise an 8-layer multi-layer perceptron (MLP) with a skip connection at the fourth layer.

In some embodiments, the neural radiance module can comprise a second multi-layer perceptron (MLP).

In some embodiments, the second MLP can comprise an 8-layer multi-layer perceptron (MLP) with a skip connection at the fourth layer.

In some embodiments, each frame can comprise a frame number. The frame number can be encoded into a high dimension feature using positional encoding.

In some embodiments, each dynamic entity can be rendered in accordance with the 3D bounding-box.

In some embodiments, intersections of a ray with the 3D bounding-box can be computed. A rendering segment of the dynamic object can be obtained in accordance with the intersections. The dynamic entity can be rendered in accordance with the rendering segment.

In some embodiments, each dynamic entity layer can be trained in accordance with the 3D bounding-box.

In some embodiments, the environment layer, the dynamic entity layers for the first dynamic entity, and the second dynamic entity can be trained together with a loss function.

In some embodiments, a proportion of each dynamic object can be calculated in accordance with the label map. The environment layer, the dynamic entity layers for the first dynamic entity, and the second dynamic entity can be trained in accordance with the proportion for the first dynamic entity and the second dynamic entity.

In some embodiments, an affine transformation to the 3D bounding box can be applied to obtain a new bounding-box. The scene can be rendered in accordance with the new bounding-box.

In some embodiments, an inverse transformation can be applied on sampled pixels for the dynamic entity.

In some embodiments, a retiming transformation can be applied to a timestamp to obtain a new timestamp. The scene can be rendered in accordance with the new timestamp. In some embodiments, the scene can be rendered without the first dynamic entity.

In some embodiments, a density value for the first dynamic entity can be scaled with a scalar. The scene can be rendered in accordance with the scaled density value for the first dynamic entity.

In some embodiments, the environment layer can comprise a neural radiance module. The neural radiance module can be configured to derive a density value and a color in accordance with the spatial coordinate, the timestamp, a direction, and a trained radiance weight.

In some embodiments, the environment layer can comprise a deformation module and a neural radiance module, the deformation module is configured to deform a spatial coordinate in accordance with a timestamp and a trained deformation weight, and the neural radiance module is configured to derive a density value and a color in accordance with the deformed spatial coordinate, the timestamp, a direction, and a trained radiance weight.

In some embodiments, the environment layer comprises a multi-layer perceptron (MLP).

These and other features of the apparatuses, systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates a system, including an editable video generation module, according to various embodiments of the present disclosure.

FIG. 2 illustrates a NeRF generating module that can volumetrically render high-resolution video frames of objects, according to various embodiments of the present disclosure.

FIGS. 3A and 3B illustrate a layered camera ray sampling scheme, according to various embodiments of the present disclosure.

FIG. 3C illustrates video frames of an editable free-viewport video rendered through a neural rendering module and a neural editing module, according to various embodiments of the present disclosure.

FIG. 4 illustrates a computing component that includes one or more hardware processors and a machine-readable storage media storing a set of machine-readable/machine-executable instructions that, when executed, cause the hardware processor(s) to perform a method, according to various embodiments of the present disclosure.

FIG. 5 is a block diagram that illustrates a computer system upon which any of various embodiments described herein may be implemented.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION OF THE EMBODIMENTS

Described herein is a solution that addresses the problems described above. In various embodiments, the claimed invention can include a machine learning model configured to generate (e.g., render) novel views of scenes depicted in media content items (e.g., images, videos, looping videos, free-viewpoint videos, etc.). Unlike the conventional methods of view synthesis, the machine learning model can generate novel views of scenes that are editable. For example, a free-viewpoint video can depict a first dynamic entity (e.g., an object, person, etc.) and a second dynamic entity of equal sizes in a scene. In this example, a size of the first dynamic entity can be altered, through the machine learning model, so that the first dynamic entity appears to be smaller (or larger) than the second dynamic entity in a rendered video. In some cases, the first dynamic entity can be removed altogether in the rendered video. In some embodiments, the machine learning model can comprise an environment layer and one or more dynamic layers for one or more objects depicted in a scene. The environment layer can be configured to encode pixels of an environment depicted in the scene in a continuous function of space and time. Similarly, the one or more dynamic layers can be configured to encode pixels of the one or more objects depicted in the scene. By encoding the environment separately from the one or more objects in separate layers (i.e., neural layers), layers representing the environment and the one or more objects are disentangled. In this way, during rendering of new novel views, individual objects in a scene can be manipulated (e.g., alter size, replicate, remove, etc.). In some embodiments, the environment layer and the one or more dynamic layers can each comprise a deformation module and a neural radiance module. The deformation module can be configured to deform (i.e., convert) voxels of a plurality of videos to train the machine learning model from their original space to a canonical space (i.e., a reference space). In this way, the voxels of the plurality of videos can be based on common coordinates. The neural radiance module can be configured to output color values and density values (e.g., intensity or opacity values) of voxels in the canonical space based on deformed voxel coordinates. Based on the colors values and the density values, novel scenes can be reconstructed. In some embodiments, the deformation module and the neural radiance module can be implemented using an 8-layer multi-layer perceptron. These and other features of the machine learning model are discussed herein.

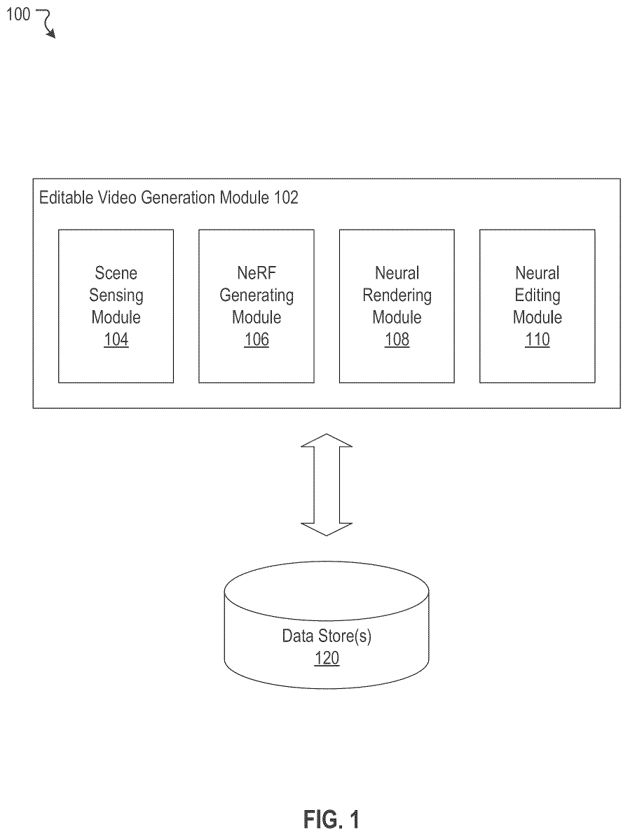

FIG. 1 illustrates a system 100, including an editable video generation module 102, according to various embodiments of the present disclosure. The editable video generation module 102 can be configured to generate an editable free-viewport video based on a plurality of videos. Unlike a traditional video in which objects depicted in a scene of the video have fixed perspectives, a free-viewport video can include visual effects. For example, a visual effect can comprise freezing a video frame depicting an object in a scene from a first perspective and then rotating the scene to a second perspective so that the object is viewed from a different viewpoint. An editable free-viewport video can provide editing capability to a free-viewport video. For example, continuing from the example above, in addition, to changing the perspective of the object, a size of the object can be changed to make the object larger or smaller. In some cases, the object can be removed altogether. As shown in FIG. 1, the editable video generation module 102 can include a scene sensing module 104, a neural radiance field (NeRF) generating module 106, a neural rendering module 108, and a neural editing module 110. Each of these modules will be discussed in further detail below.

The scene sensing module 104 can be configured to receive one or more videos depicting objects in a scene. The one or more videos can be used to train a machine learning model to generate an editable free-viewport video with novel views. In some embodiments, the one or more videos can be captured using 16 cameras (e.g., RGB cameras) arranged semicircularly to provide a 180 degree of field view. Once received, the scene sensing module 104 can generate label maps for each of the objects depicted in the scene. The label maps, in some embodiments, can be coarse space-time four-dimensional (4D) label maps comprising spatial coordinates joined with a direction. The spatial coordinates can be represented in Cartesian coordinates and the direction can be indicated by d (i.e, (x, y, z, d)). In some embodiments, the scene sensing module 104 can utilize a multi-view stereo (MVS) technique to generate point clouds (i.e., coarse dynamic point clouds) for frames (i.e., video or image frames) associated with the scene. The scene sensing module 104 can construct a depth map for each of the frames. Based on the depth map, a two-dimensional (2D) bounding-box can be generated for each of the objects depicted in the scene. In some embodiments, the scene sensing module 104 can predict a mask of each of the objects depicted in each video frame. Based on the mask, average depth values for each of the objects can be calculated based on the depth map. A refined mask can be obtained by the scene sensing module 104 based on the average depth values and the label maps of the objects can be composited (e.g., overlayed) onto the refined mask.

In some embodiments, using a trajectory prediction network (TPN), the scene sensing module 104 can generate, based on the 2D bounding-box, a three-dimensional (3D) bounding-box to enclose each of the objects depicted in the scene in its respective point clouds. Each 3D bounding-box can track an object across different point clouds of different frames with each of the point clouds corresponding to different timestamps. For example, each video frame of the one or more videos can be represented by a point cloud. In this example, for each object depicted in the one or more videos, a 3D bounding-box is generated to enclose the object and track the object across different point clouds of video frames in different timestamps. In general, a 3D bounding-box can be any shape that is suitable to enclose an object. For example, the 3D bounding-box can be a rectangular volume, square volume, pentagonal volume, hexagonal volume, cylinder, a sphere, etc. In some embodiments, the scene sensing module 104 can track an object enclosed by a 3D bounding-box using a SiamMask tracking technique. In some embodiments, the scene sensing module 104 can combine the SiamMask tracking technique with a trajectory prediction network for robust position correction during tracking. In some embodiments, the scene sensing module 104 can perform refinements to label maps to better handle occlusions between objects depicted across different frames of scenes. In this way, 3D bounding-boxes, and objects enclosed by the 3D bounding-boxes and their corresponding label maps (e.g., coarse space-time (4D) label maps) can be better handled across different frames.

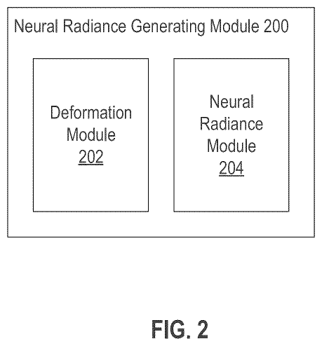

The NeRF generating module 106 can be configured to generate a spatially and temporally consistent neural radiance field (a spatio-temporal neural radiance field or ST-NeRF) for each of the objects (e.g., dynamic entities) depicted in the one or more videos. Separately, and in addition, the NeRF generating module 106 can generate an ST-NeRF for an environment depicted in the scene of the one or more videos. In this way, the objects and the environment of the scene are disentangled and each can have its own unique ST-NeRF In this way, during generation of a free-viewport video, the objects are rendered individually and separately from the environment. As such, some or all of the objects can be manipulated in their own individual way. For example, the one or more videos depict a first person and a second person in a classroom setting. In this example, the first person, the second person, and the classroom setting can each be encoded in its own unique ST-NeRF. During reconstruction of the scene into a free-viewport video, the first person and/or the second person may be altered in the classroom setting. For example, the first person can be made smaller (or larger) than the second person in the classroom setting. In some cases, the first person can be replicated in the classroom setting during reconstruction of the free-viewport video. In some embodiments, the NeRF generating module 106 can generate an ST-NeRF for each of the objects based on their corresponding 3D bounding-boxes. As such, when each of the objects is later rendered, their corresponding 3D bounding-boxes remain intake and rendering takes place within the 3D bounding-boxes. The NeRF generating module 106 will be discussed in greater detail with reference to FIG. 2 herein.

The neural rendering module 108 can be configured to provide, in addition to generating novel views, an editable free-viewport video. To accomplish this, the neural rendering module 108 can encode each of the objects and the environment as a continuous function in both space and time into its own unique ST-NeRF. In some embodiments, each ST-NeRF corresponding to each of the objects can be referred to as layers (or neural layers). Likewise, an ST-NeRF corresponding to the environment of the scene (i.e., the background) can be referred to as an environment layer or an environment neural layer. Because each of the objects and the environment have its own unique layers, each of the objects and the environment become editable during reconstruction of the editable free-viewport video. As such, the neural rendering module 108 can provide editable photo-realistic functions. For example, a free-viewpoint video can depict a first object and a second object of equal sizes in a scene. In this example, a size of the first object can be altered, by querying spatial coordinates of voxels corresponding to the first object through its ST-NeRF, to make the first object appear smaller (or larger) than the second object in the scene. In some cases, copies of the first object can be replicated and inserted into the scene along with the second object. In some cases, the first object can be removed from the scene. Many manipulations are possible. In general, during reconstruction of the editable free-viewport video, the neural rendering module 108 can query various ST-NeRFs (i.e., layer or neural layers) to render photo-realistic scenes in the editable free-viewport video.

In general, during reconstruction of the editable free-viewport video, each of the objects being rendered in the editable free-viewport video is based on querying the ST-NeRF encoded in respective 3D bounding-boxes. In some cases, the neural rendering module 108 can apply an affine transformation to the 3D bounding boxes to obtain new bounding-boxes. The neural rendering module 108 can render the objects based on the new bounding-boxes. In some embodiments, the neural rendering module 108 can apply retiming transformation to video frames of the editable free-viewport video to obtain new timestamps for the video frames. The neural rendering module 108 can render the objects based on the new timestamps. Such transformations may be applied to remove an object from a scene. In some embodiments, the neural rendering module 108 can scale density values outputted through ST-NeRFs with a scalar value. The neural rendering module 108 can render the objects based on the scaled density values. Many variations are possible.

In some embodiments, the neural rendering module 108 can be configured to construct (i.e., assemble) a novel view of a scene from a point set (i.e., a location of a virtual camera placed into the scene) based on final color values. The neural rendering module 108 can construct the novel view by merging voxel points of segments of camera rays emanating from a point set. In some embodiments, voxel points associated with a point set can be expressed as follows:

[symbol]

=∪_{ief} [symbol] ⁱ

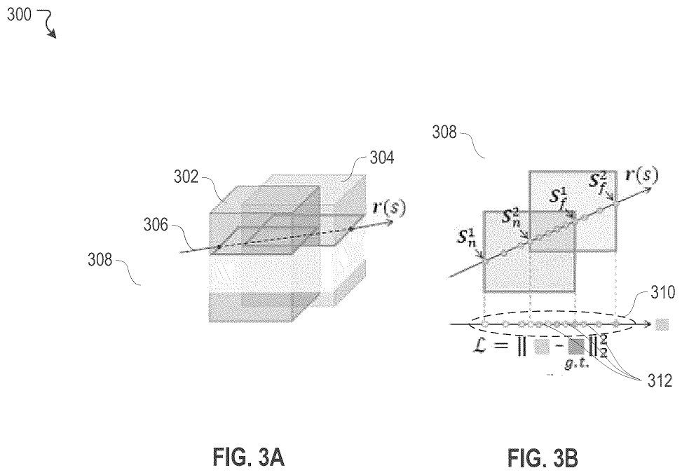

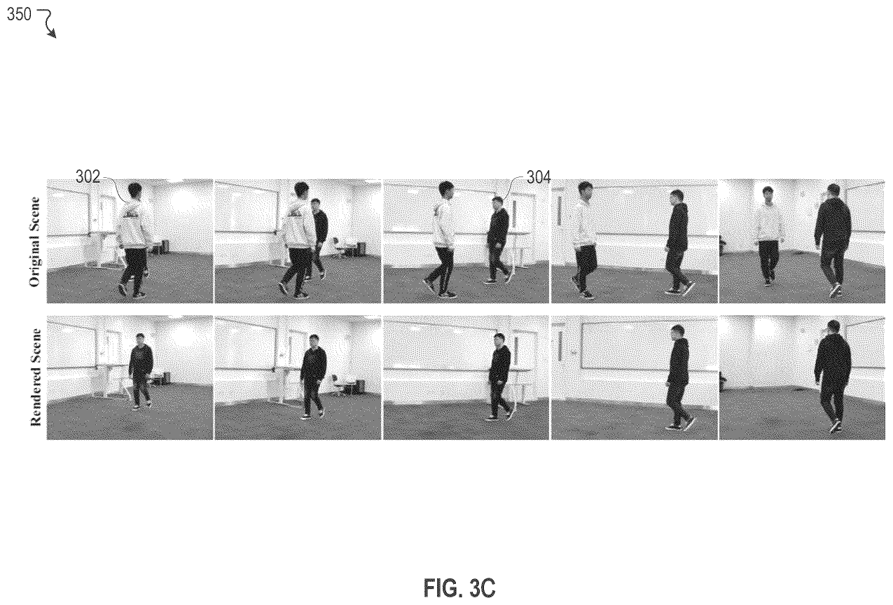

These voxel points can be sorted, based on their depth values, from nearest to farthest from the point set. The neural rendering module 108 can construct the novel view of the scene by summing final color values of the voxel points. This operation by the neural rendering module 108, can be expressed as follows:

$$\hat{C} ( r ) = {{\sum }^{\vert 𝒫 \vert}}_{j = 1} T ( {p}_{j} ) [ ( 1 - exp ( - σ ( {p}_{j} ) δ ( {p}_{j} ) ) c ( {p}_{j} ) ]$$

$$T ( {p}_{j} ) = exp ( - {{\sum }^{j - 1}}_{k = 1} σ ( {p}_{k} ) δ ( {p}_{k} ) ) ,$$

where Ĉ(r) is final color values of voxel points constituting the novel view; δ(pⱼ) is a distance between a j-th voxel point and a voxel point adjacent to the j-th voxel point and can be expressed as δ(pⱼ)=pⱼ₊₁−pⱼ; σ(pⱼ) is a density value of the j-th voxel point, and c(pⱼ) is a color value of the j-th voxel point. For hierarchical sampling and rendering, voxel points associated with a point set can be determined through a coarse sampling stage, [symbol] _{c}, and a fine sampling stage, [symbol] _{f}. These voxel points can be combined (i.e., merged) for novel view construction. In such scenarios, the voxel points making up a novel view can be expressed as a union between voxel points determined through the coarse sampling stage and voxel points determined through the fine sampling stage (i.e., [symbol] ⁱ= [symbol] _{c}ⁱ ∪ [symbol] _{f}ⁱ). In this way, novel views synthesized through the neural rendering module 108 can optimally handle occlusions in scenes. Rendering results of the neural rendering module 108 will be discussed with reference to FIG. 3C herein.

The neural editing module 110 can be configured to edit or manipulate the objects during rendering of the editable free-viewport video. For example, the neural editing module 110 can remove an object from a scene of the editable free-viewport video by instructing the neural rendering module 108 not to query the ST-NeRF of the object. In general, the neural editing module 110 works in conjunction with the neural rendering module 108 in modifying, editing, and/or manipulating the objects being rendering in the editable free-viewport video. The neural editing module 110 will be discussed in further detail with reference to FIG. 3C.

In some embodiments, the neural editing module 110 can be configured to identify rays passing through 3D bounding-boxes in a video frame (i.e., a scene) of the free-viewport video. For each of the rays, the neural editing module 110 can identify voxels of the video frame corresponding to the rays. Once identified, the neural editing module 110 can provide spatial coordinates and directions of these voxels to the ST-NeRF to obtain corresponding density values and color values for the voxels. The density values and the color values can be used to render (i.e., synthesize) novel views of the free-viewport video. In some embodiments, the neural editing module 110 can determine RGB losses of voxels by computing L2-norm of color values of voxels and compare the color values with ground truth color associate with the voxels.

In some embodiments, the neural editing module 110 can be configured to manipulate 3D bounding-boxes enclosing objects (e.g., dynamic entities) depicted in a scene of the free-viewport video. Because in ST-NeRF representation, poses of the objects are disentangled from implicit geometries of the objects, the neural editing module 110 can manipulate the 3D bounding-boxes individually. In some embodiments, the neural editing module 110 can composite a target scene by first determining placements of the 3D bounding-boxes Bₜⁱ of the objects (i.e., a dynamic entity) in the scene. Once determined, a virtual camera is placed into the scene to generate camera rays that pass through the 3D bounding-boxes and the scene. A segment (e.g., a portion) of a camera ray that intersects a 3D bounding-box in the scene can be determined if the camera ray intersects the 3D bounding-box at two intersections. If so, the segment is considered to be a valid segment and is indexed by the neural editing module 110. Otherwise, the segment is deemed to be invalid and the segment is not indexed by the neural editing module 110. In some embodiments, a segment of a camera ray intersecting a 3D bounding outline can be expressed as follows:

$${s}_{j}^{i} = \{ {s}_{n}^{i} , {s}_{f}^{i} \vert {s}_{n}^{i} < {s}_{f}^{i} \}$$

where sⱼⁱ denotes a segment of a camera ray intersecting an i-th 3D bounding polygon of a scene;
j indicates whether the segment of the camera ray is a valid segment or an invalid segment; and
sₙⁱ and s_{f}ⁱ correspond to depth values of first and second intersection points intersecting the i-th 3D bounding-box.

In some embodiments, to conserve computing resources, a hierarchical sampling strategy is deployed to synthesize of novel views. The hierarchical sampling can include a coarse sampling stage and a fine sampling stage. During the coarse sampling stage, each of valid segments of camera rays are partitioned into N evenly-spaced bins. Once partition, one segment is selected uniformly at random from each of the N evenly-spaced bins. This selected segment can be expressed as follows:

$${s}_{j}^{i} \sim 𝒰 [ {s}_{n}^{i} + \frac{j - 1}{N} ( {s}_{f}^{i} - {s}_{n}^{i} ) , {s}_{n}^{i} + \frac{j}{N} ( {s}_{f}^{i} - {s}_{n}^{i} ) ] , j ∈ [ 1 , 2 , … , N ] ,$$

where sⱼⁱ is a depth value of a j-th sampled voxel point on a camera ray; [symbol] denotes the evenly-spaced bins; and sₙⁱ and s_{f}ⁱ correspond to depth values of first and second voxel points intersecting an i-th 3D bounding-box. From these randomly selected segments, a probability density distribution voxels indicating a surface of an object can be determined based on density values of the randomly selected voxel points using inverse transform sampling. The fine sampling stage can be performed based on the probability density distribution. The coarse sampling stage and the fine sampling stage are discussed in further detail with reference to FIGS. 3A and 3B herein.

In some embodiments, the system 100 can further include at least one data store 120. The editable video generation module 102 can be coupled to the at least one data store 120. The editable video generation module 102 can be configured to communicate and/or operate with the at least one data store 120. The at least one data store 120 can store various types of data associated with the editable video generation module 102. For example, the at least one data store 120 can store training data to train the NeRF generating module 106 for reconstruction of editable free-viewport videos. The training data can include, for example, images, videos, and/or looping videos depicting objects. For instance, the at least one data store 120 can store a plurality of video captured by one or more cameras arranged semicircularly with a field of view of 180 degrees.

FIG. 2 illustrates a NeRF generating module 200 that can volumetrically render high-resolution video frames of objects, according to various embodiments of the present disclosure. In some embodiments, the NeRF generating module 200 can be implemented as the NeRF generating module 106 of FIG. 1. As discussed above, once trained, the NeRF generating module 200 can be configured to volumetrically render high-resolution video frames (e.g., images) of objects in new orientations and perspectives. As shown in FIG. 2, in some embodiments, the NeRF generating module 200 can comprise a deformation module 202 and a neural radiance module 204.

In some embodiments, the deformation module 202 can be configured to receive one or more videos (e.g., multi-layer videos) depicting objects in a scene. The one or more videos can also include 3D bounding-boxes associated with the objects. Each voxel of video frames of the one or more videos can be represented by three attributes: a position p, a direction d, and a timestamp to. In such cases, the deformation module 202 can output a deformed position p′ based on inputted voxel position p and timestamp t. The deformed position p′ indicates a position of a voxel in a canonical space. The timestamp t indicates the capture timing of a video frame. For every voxel, the neural radiance module 204 can output a density value σ, a color value c based on deformed position p′, a direction d. The density value σ indicates an opacity value of the voxel in the canonical space. The color value c indicates a color value of the voxel in the canonical space. Based on deformed positions, density values, and color values, novel views of the one or more videos can be volumetrically rendered.

In some embodiments, the deformation module 202 can be configured to deform (i.e., convert) voxels of the one or more videos from different spaces and time into a canonical space (i.e., a reference space). The deformation module 202 can output corresponding spatial coordinates of voxels of the canonical space based on the voxels of the one or more videos. In some embodiments, the deformation module 202 can be based on a multi-layer perceptron (MLP) to handle the free-viewport videos in various orientations or perspectives. In one implementation, the deformation module 202 can be implemented using an 8-layer multi-layer perceptron (MLP) with a skip connection at the fourth layer. By using an MLP-based deformation network, identifications (i.e., frame ID or frame number) of the frames the one or more videos can be directly encoded into a higher dimension feature without requiring additional computing and storage overhead as commonly used in conventional techniques. In some embodiments, the deformation module 202 can be represented as follows:

Δp=ϕ^{d}(p,t,θ^{d})

where Δp is changes in voxel coordinates from an original space to the canonical space: p is voxel coordinates of the original space; t is an identification of the original space; and θ^{d} is a parameter weight associated with the deformation module 202. Upon determining the changes in the voxel coordinates from the original space to the canonical space, deformed voxel coordinates in the canonical space can be determined as follows:

$${p}^{′} = p + Δ p$$

where p′ is the deformed voxel coordinates in the canonical space; p is the voxel coordinates in the original space; and Δp is the changes in voxel coordinates from the original space to the canonical space. As such, the deformation module 202 can output corresponding voxel coordinates of the canonical space based on inputs of voxel coordinates of the plurality of images.

The neural radiance module 204 can be configured to encode geometry and color of voxels of objects depicted in the one or more videos into a continuous density field. Once the neural radiance module 204 is encoded with the geometry and the color of the voxels (i.e., trained using the one or more videos), the neural radiance module 204 can output color values, intensity values, and/or opacity values of any voxel in an ST-NeRF based on a spatial position of the voxel and generate high-resolution video frames based on the color values, the intensity values, and the opacity values. In some embodiments, the neural radiance module 204 can be based on a multi-layer perceptron (MLP) to handle the plurality of images acquired in various orientations or perspectives. In one implementation, the neural radiance module 204 can be implemented using an 8-layer multi-layer perceptron (MLP) with a skip connection at the fourth layer. In some embodiments, the neural radiance module 254 can be expressed as follows:

ϕ^{r}(p′,d,t,θ^{r})=(c,σ)

where σ is a density value of voxels (e.g., intensity values and/or opacity values); c is a color value of voxels; p′ is the deformed voxel coordinates in the canonical space; d is a direction of a ray, t is an identification of an original space of a video frame; and θ^{r} is a parameter weight associated with the neural radiance module 204. As such, once trained, the neural radiance module 204 can output color values, intensity values, and/or opacity values of voxels of the canonical space based on inputs of the deformed voxel coordinates. In this machine learning architecture, both geometry and color information across views and time are fused together in the canonical space in an effective self-supervised manner. In this way, the NeRF generating module 200 can handle inherent visibility of the objects depicted in the plurality of images and high-resolution images can be reconstructed.

FIGS. 3A and 3B illustrate a layered camera ray sampling scheme 300, according to various embodiments of the present disclosure. FIG. 3A shows a first 3D bounding-box 302 and a second 3D bounding-box 304 being intersected by a camera ray 306 generated by a virtual camera (not shown) placed in a scene. FIG. 3B shows a vertical projection of a horizontal plane 308 on which the first 3D bounding-box 302, the second 3D bounding-box 304, and the camera ray 306 are disposed. This horizontal plane is imaginary and is provided for illustration purposes only. Diagram (b) shows that the camera ray 306 intersects the first 3D bounding-box 302 and second 3D bounding-box 304 at voxel points corresponding to sₙ¹, s_{f}¹, sₙ², and s_{f}², respectively. The determination of the voxel points corresponding to sₙ¹, s_{f}¹, sₙ², and s_{f}², is referred to coarse sampling. Based on these voxel points, a probability density distribution 310 of voxels indicating a surface of an object using inverse transform sampling Based on the probability density distribution 310, a set of voxel points 312 in addition to the voxel points corresponding to sₙ¹, s_{f}¹, sₙ², and s_{f}², can be determined. The determination of the set of voxel points 312 is referred to fine sampling.

FIG. 3C illustrates video frames 350 of an editable free-viewport video rendered through a neural rendering module and a neural editing module, according to various embodiments of the present disclosure. In some embodiments, the neural rendering module and the neural editing module can be implemented as the neural rendering module 108 and the neural editing module 110 of FIG. 1. In some embodiments, the video frames 350 can be video frames (e.g., images) rendered through the neural rendering module 108 of FIG. 1. FIG. 3C depicts an example of removing an object out from an editable free-viewport video based on the technology disclosed herein. FIG. 3C shows a scene (i.e., “Original Scene”) of the editable free-viewport video in which person A 352 and person B 354 are walking toward and pass each other. This editable free-viewport video can be encoded into one or more ST-NeRFs by the neural rendering module. By disentangling poses of person A 352 and person B 354 from their implicit geometry in the scene, person A 352 and person B 354 can be manipulated through the neural editing module. FIG. 3C shows a rendered scene of the same scene of the free-viewport video in which person A 352 has been removed from the rendered scene.

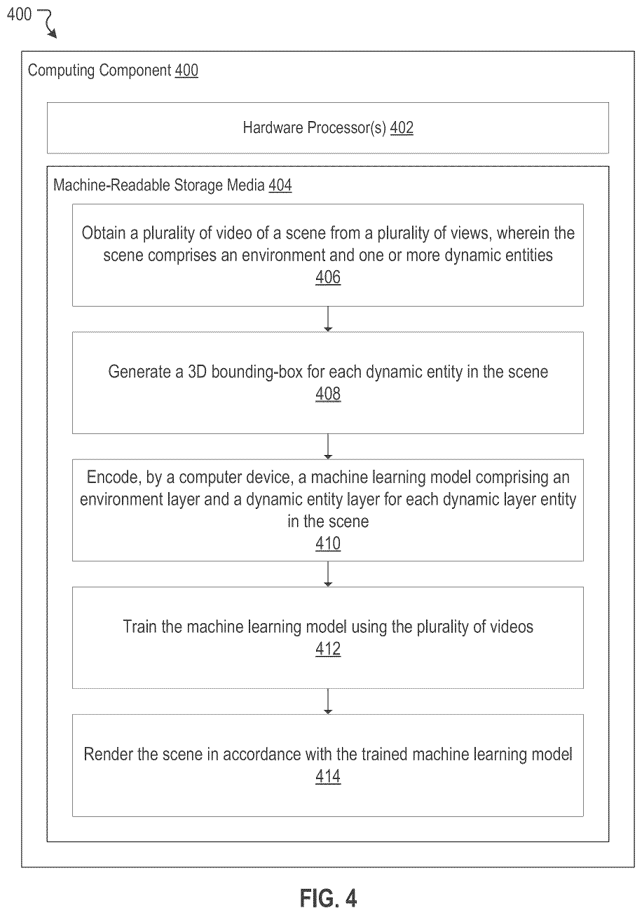

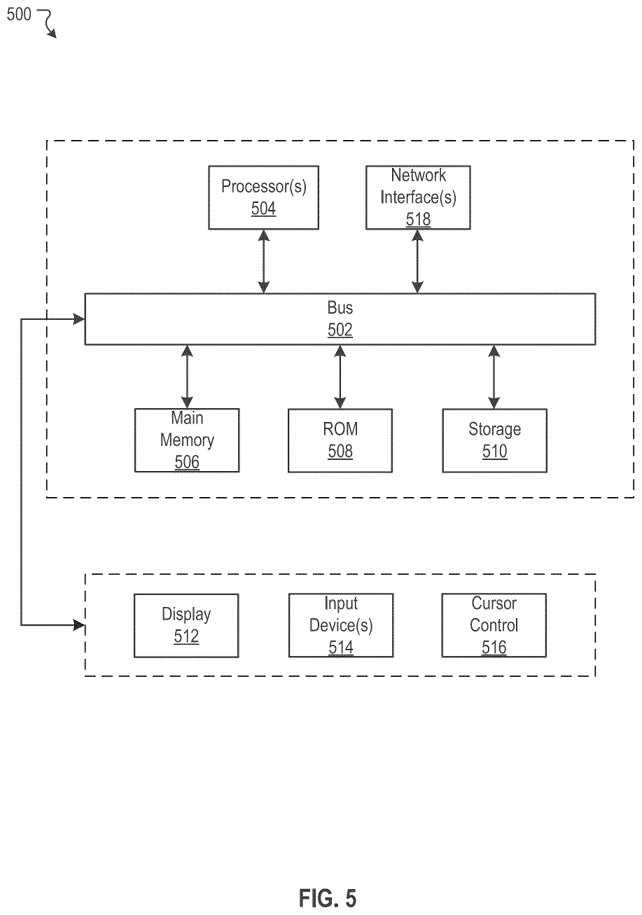

FIG. 4 illustrates a computing component 400 that includes one or more hardware processors 402 and a machine-readable storage media 404 storing a set of machine-readable/machine-executable instructions that, when executed, cause the hardware processor(s) 402 to perform a method, according to various embodiments of the present disclosure. The computing component 400 may be, for example, the computing system 500 of FIG. 5. The hardware processors 402 may include, for example, the processor(s) 504 of FIG. 5 or any other processing unit described herein. The machine-readable storage media 404 may include the main memory 506, the read-only memory (ROM) 508, the storage 510 of FIG. 5, and/or any other suitable machine-readable storage media described herein.

At block 406, the processor 402 can obtain a plurality of video of a scene from a plurality of views, wherein the scene comprises an environment and one or more dynamic entities.

At block 408, the processor 402 can generate a 3D bounding-box for each dynamic entity in the scene.

At block 410, the processor 402 can encode a machine learning model comprising an environment layer and a dynamic entity layer for each dynamic entity in the scene, wherein the environment layer represents a continuous function of space and time of the environment, and the dynamic entity layer represents a continuous function of space and time of the dynamic entity, wherein the dynamic entity layer comprises a deformation module and a neural radiance module, the deformation module is configured to deform a spatial coordinate in accordance with a timestamp and a trained deformation weight, and the neural radiance module is configured to derive a density value and a color in accordance with the deformed spatial coordinate, the timestamp, a direction, and a trained radiance weight.

At block 412, the processor 402 can train the machine learning model using the plurality of videos.

At block 414, the processor 402 can render the scene in accordance with the trained machine learning model.

The techniques described herein, for example, are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination.

FIG. 5 is a block diagram that illustrates a computer system 500 upon which any of various embodiments described herein may be implemented. The computer system 500 includes a bus 502 or other communication mechanism for communicating information, one or more hardware processors 504 coupled with bus 502 for processing information. A description that a device performs a task is intended to mean that one or more of the hardware processor(s) 504 performs.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to output device(s) 512, such as a cathode ray tube (CRT) or LCD display (or touch screen), for displaying information to a computer user. Input device(s) 514, including alphanumeric and other keys, are coupled to bus 502 for communicating information and command selections to processor 504. Another type of user input device is cursor control 516. The computer system 500 also includes a communication interface 518 coupled to bus 502.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features, characteristics, and parameters as the another component.

What is claimed is:

1. A computer-implemented method, comprising:
obtaining a plurality of video of a scene from a plurality of views, wherein the scene comprises an environment and one or more dynamic entities;
generating a 3D bounding-box for each dynamic entity of the one or more dynamic entities in the scene;
encoding, by a computer device, a machine learning model comprising an environment layer and a dynamic entity layer for each dynamic entity in the scene, wherein the environment layer represents a continuous function of space and time of the environment, and the dynamic entity layer represents a continuous function of space and time of the dynamic entity, wherein the dynamic entity layer comprises a deformation module and a neural radiance module, the deformation module is configured to deform a spatial coordinate in accordance with a timestamp and a trained deformation weight to obtain a deformed spatial coordinate, and the neural radiance module is configured to derive a density value and a color in accordance with the deformed spatial coordinate, the timestamp, a direction, and a trained radiance weight;
training the machine learning model using the plurality of videos to obtain a trained machine learning model; and
rendering the scene in accordance with the trained machine learning model.

2. The computer-implemented method of claim 1, wherein the scene comprises a first dynamic entity and a second dynamic entity.

3. The computer-implemented method of claim 1, further comprising:
obtaining a point cloud for each frame of the plurality of videos, wherein each video of the plurality of videos comprises a plurality of frames;
reconstruct a depth map for each view to be rendered to obtain a reconstructed depth map;
generating an initial 2D bounding-box in each view for each dynamic entity; and
generating the 3D bounding-box for each dynamic entity using a trajectory prediction network (TPN).

4. The computer-implemented method of claim 3, further comprising:
predicting a mask of a dynamic object in each frame from each view;
calculating an averaged depth value of the dynamic object in accordance with the reconstructed depth map;
obtaining a refined mask of the dynamic object in accordance with the averaged depth value; and
compositing a label map of the dynamic object in accordance with the refined mask.

5. The computer-implemented method of claim 1, wherein the deformation module comprises a multi-layer perceptron (MLP).

6. The computer-implemented method of claim 5, wherein the deformation module comprises an 8-layer multi-layer perceptron (MLP) with a skip connection at a fourth layer.

7. The computer-implemented method of claim 3, wherein each frame comprises a frame number, and the frame number is encoded into a high dimension feature using positional encoding.

8. The computer-implemented method of claim 1, further comprising:
rendering each dynamic entity in accordance with the 3D bounding-box.

9. The computer-implemented method of claim 8, further comprising:
computing intersections of a ray with the 3D bounding-box;
obtaining a rendering segment of the dynamic object in accordance with the intersections; and
rendering the dynamic entity in accordance with the rendering segment.

10. The computer-implemented method of claim 2, further comprising:
training each dynamic entity layer in accordance with the 3D bounding-box.

11. The computer-implemented method of claim 10, further comprising:
training the environment layer, the dynamic entity layers for the first dynamic entity, and the second dynamic entity together with a loss function.

12. The computer-implemented method of claim 11, further comprising:
calculating a proportion of each dynamic object in accordance with a label map;
training the environment layer, the dynamic entity layers for the first dynamic entity and the second dynamic entity in accordance with the proportion for the first dynamic entity and the second dynamic entity.

13. The computer-implemented method of claim 2, further comprising:
applying an affine transformation to the 3D bounding box to obtain a new bounding-box; and
rendering the scene in accordance with the new bounding-box.

14. The computer-implemented method of claim 13, further comprising:
applying an inverse transformation on sampled pixels for the dynamic entity.

15. The computer-implemented method of claim 2, further comprising:
applying a retiming transformation to the timestamp to obtain a new timestamp; and
rendering the scene in accordance with the new timestamp.

16. The computer-implemented method of claim 2, further comprising:
rendering the scene without the first dynamic entity.

17. The computer-implemented method of claim 2, further comprising:
scaling a density value for the first dynamic entity with a scalar to obtain a scaled density value; and
rendering the scene in accordance with the scaled density value for the first dynamic entity.

18. The computer-implemented method of claim 1, wherein the environment layer comprises a neural radiance module, and the neural radiance module is configured to derive a density value and a color in accordance with the spatial coordinate, the timestamp, a direction, and a trained radiance weight.

19. The computer-implemented method of claim 1, wherein the environment layer comprises a deformation module and a neural radiance module, the deformation module is configured to deform a spatial coordinate in accordance with a timestamp and a trained deformation weight, and the neural radiance module is configured to derive a density value and a color in accordance with the deformed spatial coordinate, the timestamp, a direction, and a trained radiance weight.

20. The computer-implemented method of claim 1, wherein the environment layer comprises a multi-layer perceptron (MLP).
